(19) United States
(12) Patent Application Publication
(10) Pub. No.: US 2024/0202671 A1
(43) Pub. Date: Jun. 20, 2024

(54) DATA MANAGEMENT SYSTEMS AND METHODS

(71) Applicant: Caterpillar Inc., Peoria, IL (US)

(72) Inventors: Venkata S. NANDAGOPALAN, Udumalpet (IN); Derek J. HOPPER, Peoria, IL (US); Franklin GERALD, Chennal (IN); Satheesh K. BALU, Thanjavur (IN); Sucheta CHITGOPEKAR, Hoffman Estates, IL (US); Spencer CREE, Peoria, IL (US); Wyatt PAGE, Golden, CO (US)

(73) Assignee: Caterpillar Inc., Peoria, IL (US)

(21) Appl. No.: 18/287,105

(22) PCT Filed: Apr. 13, 2022
(86) PCT No.: PCT/US2022/024545

§ 371 Date: Oct. 16, 2023

(30) Foreign Application Priority Data
Apr. 15, 2021 (IN) 202111017485

(51) Int. Cl. G06Q 10/20

(52) U.S. Cl. CPC G06Q 10/20

(57) ABSTRACT

A method includes, with a processor executing computer-readable instructions stored within a memory device, displaying, on a display device and via at least one graphical user interface (GUI), a first interface element associated with a machine selection, receiving, via the first interface element, a first input comprising an indication of a machine, receiving, via the first interface element, a second input comprising an indication to download parts and service information associated with the machine, initiating a download of the parts and service information associated with the machine from a computing device, receiving the downloaded parts and service information associated with the machine, storing the downloaded parts and service information associated with the machine in a mobile computing device associated with the processor, and accessing the downloaded parts and service information associated with the machine using the mobile computing device when no data network connection is available.

### TECHNICAL FIELD

The present disclosure relates to mobile data access tools, and more particularly, to a system and method for managing parts and service data for particular machines in an offline and online manner.

### BACKGROUND

Many types of machines operate in remote areas have limited access to data communication networks, such as the Internet or cellular communication networks. In some areas, there are no accessible data communication networks. For example, construction machines, earth moving equipment, remote power systems, and the like may operate in areas that are distant from access to data communication networks. Additionally, machines that work underground, dig tunnels, and the like may be blocked by earth, rocks, and other materials from accessing any data communication network.

Although these remote areas may not have accessible data communication networks, workers (e.g., repair technicians) in these areas may want to perform services and repairs on the machines operating at these job sites. For example, if a machine breaks or is malfunctioning, it may impact the entire job being performed at the job site. Thus, it may be important to get the broken or malfunctioning machine working quickly.

In some existing systems, a worker at a remote job site may want to access online parts and service information associated with the broken malfunctioning machine. The online parts and service information may include text data, image data, video data, and the like to assist the worker in diagnosing and/or repairing the machine. However, if no data communication networks are available at the job site, the online parts and service information is not available to the worker.

In these situations when no data communication networks are available, existing systems may allow a worker to use previously downloaded parts and service information to diagnose and/or repair the machine. For example, the downloaded parts and service information may be distributed periodically on a USB (Universal Serial Bus) storage device. If updated USB storage devices are distributed several times per year, the information on the USB storage device may become obsolete quickly.

In other situations, the stored data may contain a voluminous amount of information that is difficult and time-consuming to sort through. The data set is large because it contains information associated with all possible machines and systems manufactured by one or more companies. In some examples, a particular company may produce hundreds or thousands of different machines where each machine contains hundreds or thousands of different systems and parts. In these examples, the amount of information associated with all of the machines, systems, and parts may include tens of thousands (or more) pieces of information. To minimize the size of the stored data (and the time required to sort through the data to find the appropriate machine), only a portion of the available parts and service information may be available for a particular machine. For example, since video data takes a significant amount of storage space, step-by-step guided videos may not be provided to maintain a reasonable data storage requirement. Unfortunately, these types of guided videos may be the most valuable diagnostic and repair information for a worker.

Examples of the present disclosure are directed toward overcoming the deficiencies described above.

### SUMMARY

In an example of the present disclosure, a method includes, with a processor executing computer-readable instructions stored within a memory device, displaying, on a display device and via at least one graphical user interface (GUI), a first interface element associated with a machine selection, receiving, via the first interface element, a first input comprising an indication of a machine, receiving, via the first interface element, a second input comprising an indication to download parts and service information associated with the machine, initiating a download of the parts and service information associated with the machine from a computing device, receiving the downloaded parts and service information associated with the machine, storing the downloaded parts and service information associated with the machine in a mobile computing device associated with the processor, and accessing the downloaded parts and service information associated with the machine using the mobile computing device when no data network connection is available.

In an example of the present disclosure, a method includes, with a processor executing computer-readable instructions stored within a memory device, identifying a machine being repaired, identifying replaceable parts associated with the machine, selecting a replaceable part to evaluate, determining a desired frequency of replacement for the replaceable part, determining an actual frequency that the replacement part was purchased from the manufacturer, and, if the desired frequency of replacement for the replaceable part is greater than the actual frequency, classifying the replaceable part as a non-authentic replaceable part.

In an example of the present disclosure, one or more non-transitory computer readable media store instructions that, when executed by one or more processors, configure a computing device to perform operations comprising displaying, on a display device and via at least one graphical user interface (GUI), a first interface element associated with a machine selection, receiving, via the first interface element, a first input comprising an indication of a machine, receiving, via the first interface element, a second input comprising an indication to download parts and service information associated with the machine, initiating a download of the parts and service information associated with the machine from a computing device, receiving the downloaded parts and service information associated with the machine, storing the downloaded parts and service information associated with the machine in a mobile computing device associated with the processor, and accessing the downloaded parts and service information associated with the machine using the mobile computing device when no data network connection is available.

### BRIEF DESCRIPTION OF DRAWINGS

FIG. 1 is a schematic illustration of an exemplary environment for data management systems and methods using a graphical user interface (GUI) as described herein, according to aspects of this disclosure.

FIG. 2 is a schematic illustration of an exemplary mobile application as described herein, according to aspects of this disclosure.

FIG. 3 is a flowchart showing a method of downloading and updating data associated with at least one machine, according to aspects of this disclosure.

FIG. 4 is a flowchart showing a method of performing service on a machine or troubleshooting a problem with the machine, according to aspects of this disclosure.

FIG. 5 is a flowchart showing a method of determining whether a particular part is an authentic machine part, according to aspects of this disclosure.

FIG. 6 is a schematic illustration of a GUI for selecting a machine, according to aspects of this disclosure.

FIG. 7 is a schematic illustration of a GUI displaying various notifications associated with a particular machine, according to aspects of this disclosure.

FIG. 8 is a schematic illustration of a GUI displaying various systems and components associated with a particular machine, according to aspects of this disclosure.

FIG. 9 is a schematic illustration of a GUI displaying various systems and components associated with an engine and related systems, according to aspects of this disclosure.

FIG. 10 is a schematic illustration of a GUI displaying various information available regarding a particular product, according to aspects of this disclosure.

FIG. 11 is a schematic illustration of a GUI displaying example individual parts associated with a fuel filter, according to aspects of this disclosure.

FIG. 12 is a schematic illustration of a GUI displaying an example shopping cart list of parts for a particular machine component, according to aspects of this disclosure.

FIG. 13 is a schematic illustration of a GUI displaying an example fuel filter 3D parts image for a machine system, according to aspects of this disclosure.

FIG. 14 is a schematic illustration of a GUI displaying example parts associated with a machine component and an option to add parts to a shopping cart, according to aspects of this disclosure.

FIG. 15 is a schematic illustration of a GUI displaying available parts and service information related to a machine component, according to aspects of this disclosure.

FIG. 16 is a schematic illustration of a GUI displaying available information related to systems operation, troubleshooting, and testing/adjusting, according to aspects of this disclosure.

FIG. 17 is a schematic illustration of a GUI displaying a first step in troubleshooting an example low fuel pressure warning, according to aspects of this disclosure.

FIG. 18 is a schematic illustration of a GUI displaying a second step in troubleshooting an example low fuel pressure warning, according to aspects of this disclosure.

FIG. 19 is a block diagram of a computing system for execution of a method and GUIs, according to an example of the principles described herein.

### DETAILED DESCRIPTION

Wherever possible, the same reference numbers will be used throughout the drawings to refer to the same or like parts.

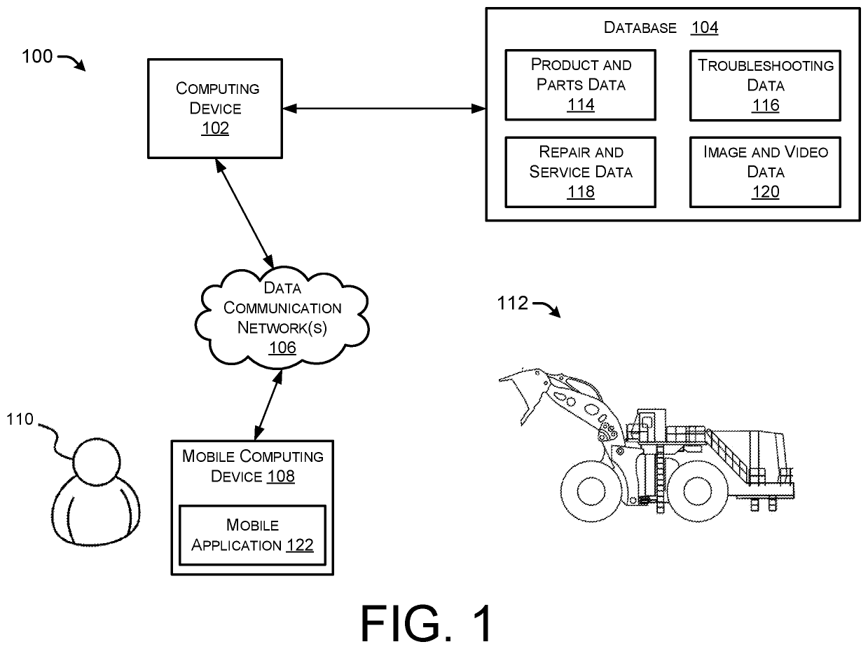

FIG. 1 is a schematic illustration of an exemplary environment or system 100 for data management systems and methods using a graphical user interface (GUI) as described herein, according to aspects of this disclosure. Components of the environment 100 may interact with each other to enable a user 110, such as a service technician or other worker, to access parts and service information associated with, for example, a machine, equipment, or other system. For example, the user 110 may need to perform troubleshooting or service activities related to a machine 112. The illustrated machine 112 is a loading machine, but the systems and methods described herein can be used with any type of machine, equipment, or other system. Other example machines may include a track-type tractor, a wheel loader, a generator set, an oil drill, an industrial transport machine, a vehicle, a work tool, and the like.

The user 110 is any person or entity associated with the machine 112. For example, the user 110 may be an owner, a customer, an operator, a technician, a repair person, a customer service representative, dealer personnel, or any other person concerned with the machine 112. The user 110 may utilize the systems and methods described herein to perform various diagnostics, troubleshooting, service, or repair activities associated with machine 112.

A computing device 102 accesses various data and information from a database 104. In some embodiments, the computing device 102 is a server capable of performing a variety of computing activities. The data contained in the database 104 may include any data associated with any type of machine, equipment, or other system, such as the machines and systems discussed herein. In some embodiments, the database 104 includes product and parts data 114, troubleshooting data 116, repair and service data 118, and image and video data 120.

As discussed herein, the data stored in the database 104 may include text data, image data, audio data, video data, and the like. The computing device 102 may communicate with the database 104 using any type of communication link, such as a wired communication link, a wireless communication link, or a combination of wired and wireless communication links. The computing device 102 may also communicate with the database 104 using one or more data communication networks, such as data communication network 106 discussed herein. In some embodiments, the database 104 is contained within computing device 102.

As shown in FIG. 1, a mobile computing device 108 may be coupled to the computing device 102 via the data communication network 106. The data communication network 106 represents any type and combination of electronic communication networks configured to communicate data between nodes connected to the data communication network 106. For example, the data communication network 106 may include the Internet, an ethernet, a local-area network, a wide-area network, a personal area network, a cellular network, a telephone network, or any combination thereof. In at least some embodiments, the data communication network 106 may include a mobile network and related infrastructure operable to provide Internet connectivity to the computing device 102 and the mobile computing device 108 such as according to a 2G, 3G, 4G, 5G, and/or LTE communication network.

The mobile computing device 108 shown in FIG. 1 may be a mobile device carried by or otherwise accessible to the user 110. In some embodiments, the mobile computing device 108 may be embodied as a smartphone, a mobile phone, a tablet computer, a personal digital assistant (PDA), a desktop computer, a laptop computer, a handheld device, a mobile device, a gaming system, among other electronic devices or other computing devices. Moreover, and as described herein, the mobile computing device 108 may include functionality to assist a user to visually access parts and service information, troubleshooting information, diagnostics information, and the like.

As discussed herein, the mobile computing device 108 includes at least one mobile application 122 configured to allow the user 110 to access various parts and service information, troubleshooting information, diagnostics information, and the like. In some embodiments, the user 110 may receive the parts and service information, troubleshooting information, or diagnostics information via one or more user interface images as described in greater detail herein.

As described herein, the system 100 of FIG. 1 provides improved systems and methods that assist a user 110 in diagnosing, troubleshooting, servicing, and repairing a machine 112. As used in the present specification and in the appended claims, the term “machine” is meant to be understood broadly as any mobile or stationary machine, equipment, or other system. In some embodiments, the machine may be associated with an industry, such as, without limitation, mining, construction, landscaping, forestry, transportation, agriculture, and the like. Non-limiting examples of machines include loading machines, excavators, backhoes, dozers, drilling machines, trenchers, and drag lines, among other types of machines. It is also to be understood that the various user interface images (e.g., GUI images) depicted throughout the figures are shown primarily for illustrative purposes to assist in disclosing features of various aspects of the present disclosure, and that the figures do not depict all of the elements of the user interface images and do not depict all types of information that may be presented in a user interface.

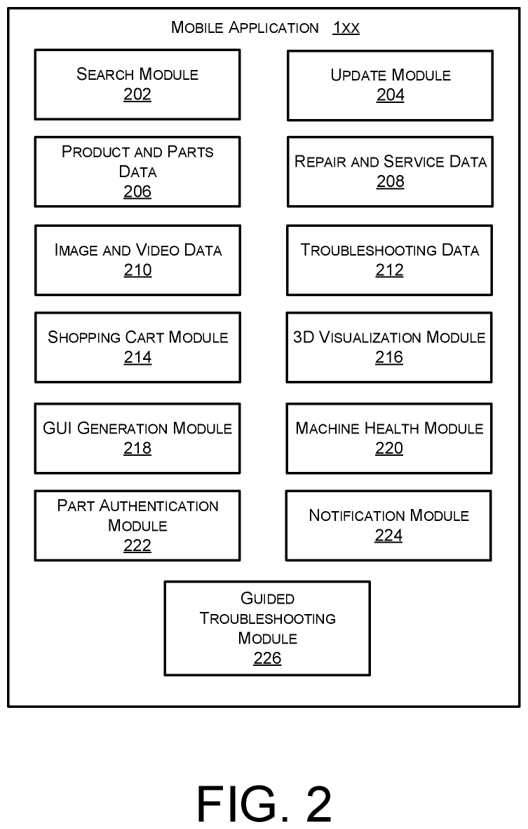

FIG. 2 is a schematic illustration of the exemplary mobile application 122 as described herein, according to aspects of this disclosure. As shown in FIG. 2, the mobile application 122 includes a search module 202 that may receive a search request associated with a machine, part, process, and the like from the user 110. In some embodiments, search module 202 may allow the user 110 to first identify a machine, then identify a system associated with the machine (e.g., the fuel system), then identify other information associated with troubleshooting, servicing, or repairing the machine. In some examples, the user 110 may enter search terms based on a machine/part number, a machine/part description, or any other identifier associated with a machine or part.

An update module 204 manages updates of data and other information stored in mobile computing device 108, as discussed herein.

Product and parts data 206 may include some or all of products and parts data 114. For example, the mobile application 122 may download a portion of the products and parts data 114 from database 104 to the mobile computing device 108 for access by the user 110 when the mobile computing device 108 cannot access a data communication network. Similarly, repair and service data 208 may include a portion of the repair and service data 118 from database 104 as downloaded by the mobile application 122. Additionally, image and video data 210 may include a portion of the image and video data 120 from database 104 as downloaded by the mobile application 122. Further, troubleshooting data 212 may include a portion of the troubleshooting data 116 from database 104 as downloaded by the mobile application 122. As discussed herein, the products and parts data 206, the repair and service data 208, the image and video data 210, and the troubleshooting data 212 can be accessed by the user 110 of mobile computing device 108 when the mobile computing device 108 cannot access a data communication network. For example, the mobile computing device 108 may not be able to access a data communication network when located in a remote area (outside the range of data communication networks), located below ground where network signals cannot penetrate the earth, or any other location where the network signals are too weak or do not reach the mobile computing device 108.

The mobile application 122 may also include a shopping cart module 214 that allows the user 110 to select parts or other items that need to be purchased for maintenance or repair of a machine. In some embodiments, shopping cart module 214 may automatically add certain parts or other items may be to a shopping cart based on the results of a diagnostics test, a troubleshooting activity, and the like.

A 3D (three-dimensional) visualization module 216 generates 3D images of machines, machine systems, parts, and the like to assist the user 110 in diagnosing problems, performing maintenance or service, repairing problems, and the like. In some embodiments, the 3D images present information to the user 110 in a manner that is more understandable than a 2D image or a text description. In some examples, 3D visualization module 216 may generate animated (e.g., moving) 3D images to show movement of a part, movement of a tool, operation of a portion of a machine, and the like.

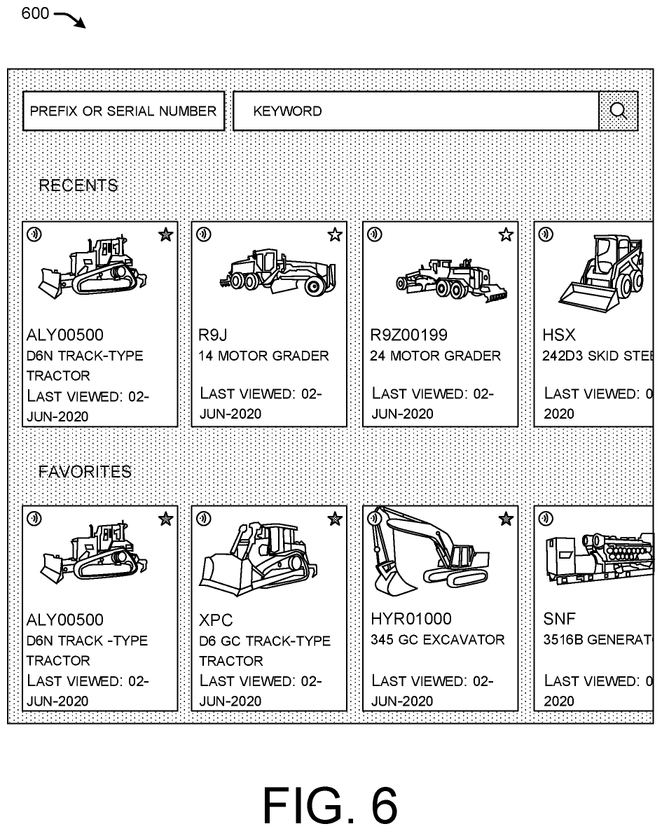

A GUI generation module 218 creates various GUI screens (e.g., GUI images) to present information to the user 110. As discussed herein, the GUI screens may include any combination of text data, 2D image data, 3D image data, animated 3D image data, audio data, and the like. Various example GUI screens that may be generated by the GUI generation module 218 are illustrated in FIGS. 6-18. In some embodiments, the GUI generation module 218 generates GUI screens based on any combination of data from product and parts data 206, repair and service data 208, image and video data 210, and troubleshooting data 212. In particular examples, the GUI generation module 218 generates GUI screens in response to a query or feedback from the user 110.

A machine health module 220 may determine the health of a particular machine based on information received about the machine, information provided by the user 110, and the like. Based on the determined health of a machine, the machine health module 220 may make recommendations (e.g., notifications to the user 110) to perform certain activities with respect to the machine, such as replacing parts, performing services, making adjustments, and the like.

A part authentication module 222 determines whether a specific part installed in a machine is an authentic part (e.g., the part is manufactured by the manufacturer of the machine). In some situations, an original part (manufactured by the manufacturer of the machine) may be replaced by a customer with a non-authentic part manufactured by a third party. The part authentication module 222 may detect these non-authentic parts and report the situation to the manufacturer of the machine or other person or entity.

A notification module 224 may generate various notifications to the user 110, a project manager, or other users or entities. For example, the notification module 224 may generate notifications related to the machine's health, service activities that are due, updated data being available for downloading, and the like. In some embodiments, the notification module 224 generates notifications based on maintenance schedules, input from the user 110, results of diagnostic tests, and the like.

A guided troubleshooting module 226 provides a step-by-step process for troubleshooting a machine problem. In some embodiments, the guided troubleshooting module 226 presents a series of steps to the user 110 and may receive feedback from the user 110 regarding the results of each step. The guided troubleshooting module 226 may present the step-by-step process using any type of data, such as text data, image data, audio data, visual data, 3D data, and the like.

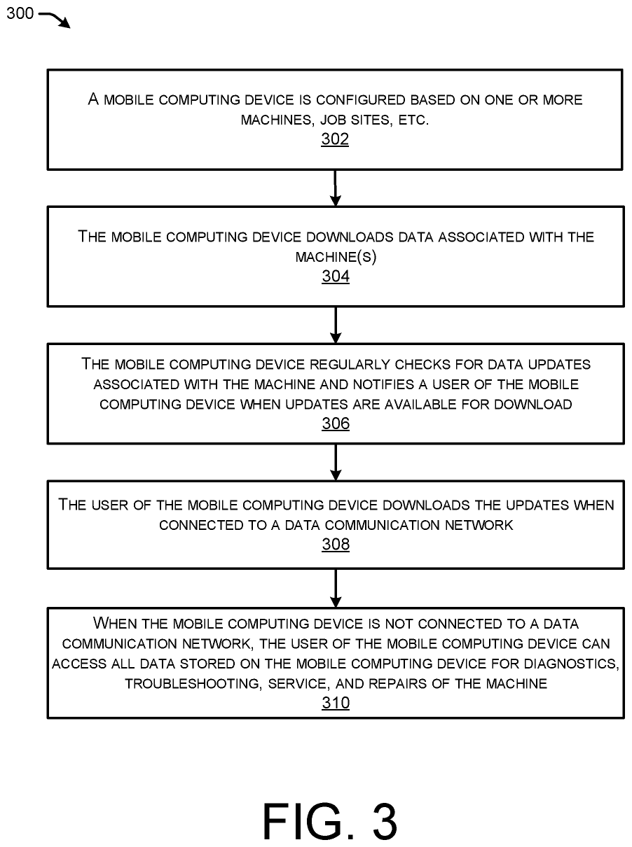

FIG. 3 is a flowchart showing a method 300 of downloading and updating data associated with at least one machine, according to aspects of this disclosure. Initially, a mobile computing device (e.g., mobile computing device 108) is configured 302 based on one or more machines, job sites, and the like. For example, if the mobile computing device will be used by a user with two machines, the mobile computing device is configured for those two machines. This configuration is used to determine what type of data needs to be downloaded into the mobile computing device to support the necessary machines when a data communication network is not available. By specifying the particular machines, the amount of data that needs to be download into the mobile computing device is limited to the data necessary for the particular machines. This approach also prevents individuals and entities from receiving confidential information about machines that the customer does not own or rent.

The method 300 continues as the mobile computing device downloads 304 data associated with the machine(s) configured at 302. In some embodiments, all data associated with the configured machine(s) is downloaded from a database (e.g., database 104). The downloaded data may include product and parts data, troubleshooting data, repair and service data, and image and video data. Since the downloaded data is limited to the configured machine(s), the amount of data downloaded is reduced. Additionally, the amount of data a user needs to search through to find relevant assistance is reduced, which allows the user to find the relevant data faster and easier.

After the relevant data is downloaded into the mobile computing device, the device regularly checks 306 for data updates associated with the machine and notifies a user of the mobile computing device when updates are available for download. In some embodiments, when checking for data updates, the check is limited to the machines that have been configured in the mobile computing device. Thus, any data updates for machines that are not configured in the mobile computing device may be ignored. In some examples, a notification is provided to the user of the mobile computing device when data updates are available for downloading. In other examples, a graphical indication may be provided on one or more GUI screens indicating whether all data is up-to-date or whether data updates are available for downloading. For example, a graphical indication that all data is up-to-date may be a green check mark, and a graphical indication that data updates are available for downloading may be an orange exclamation point.

Method 300 continues as the user of the mobile computing device downloads 308 the data updates when connected to a data communication network. In some embodiments, the user manually initiates the downloading of the data updates at their convenience. In other embodiments, the mobile computing device may automatically initiate the downloading of the data updates when a data communication network connection is established. In some examples, if a user of the mobile computing device knows that the mobile computing device will soon be used in an area without access to a data communication network, the user can perform all data updates so the data stored in the mobile computing device is up-to-date while operating in an area without data communication network access.

When the mobile computing device is not connected to a data communication network, the user of the mobile computing device can access 310 all data stored on the mobile computing device. For example, the data stored on the mobile computing device can be used for diagnostics, troubleshooting, service, and repairs of the machine. Although the mobile computing device cannot access a data communication network, the up-to-date data stored on the mobile computing device provides all relevant data regarding the machine(s) to the user of the mobile computing device.

In some examples, the mobile computing device may access data stored on the mobile computing device, if available, even if the mobile computing device can access a data communication network. This may reduce network data usage and data charges. If a particular item of information is not available on the mobile computing device, or needs to be updated, that information may be accessed via a data communication network.

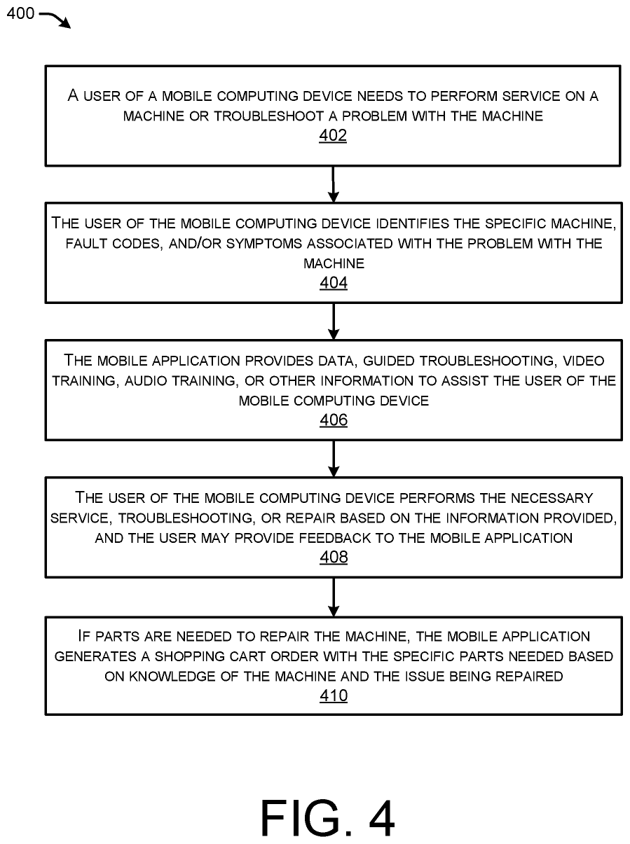

FIG. 4 is a flowchart showing a method 400 of performing service on a machine or troubleshooting a problem with the machine, according to aspects of this disclosure. Initially, a user of a mobile computing device needs to perform service 402 on a machine or troubleshoot a problem with the machine. For example, the mobile computing device may have been previously configured using the method 300 discussed above with respect to FIG. 3.

The user of the mobile computing device identifies 404 the specific machine, fault codes, and/or symptoms associated with the problem with the machine. For example, the machine may be experiencing particular symptoms or may be generating a fault code or other error that can be used by the mobile computing device to identify the problem, diagnose the problem, and/or provide instructions to the mobile computing device user.

Based on the problem with the specific machine, the mobile application (executing on the mobile computing device) provides 406 data, guided troubleshooting, video training, audio training, or other information to assist the user of the mobile computing device. The type of information provided to the user of the mobile computing device may vary depending on the complexity of the instructions being provided. Simple activities may only require a text description, whereas complex activities may benefit from an animated 3D video showing the details of the necessary activity.

The user of the mobile computing device then performs 408 the necessary service, troubleshooting, or repair based on the information provided in 406. In some examples, the user of the mobile computing device may perform a first activity, then provide feedback to the mobile application. Based on the user's feedback, the mobile application will provide the next activity to the user. For example, in a guided troubleshooting situation, the mobile application may provide a first troubleshooting activity to the user. Depending on the results of that first troubleshooting activity, the mobile application may follow one of two paths (one of two different next steps) to incrementally (or iteratively) move toward diagnosing the problem with the machine. Once the problem is diagnosed, the mobile application may provide one or more additional activities for the user to perform to fix the problem or mitigate the problem.

Depending on the problem, one or more parts may be needed to repair or service the machine. If parts are needed to repair the machine, the mobile application generates 410 a shopping cart order with the specific parts needed based on knowledge of the machine and the issue being repaired. If the mobile computing device is connected to a data communication network, the shopping cart order may be manually placed by the user of the mobile computing device or automatically placed by the mobile application. If the mobile computing device is not connected to a data communication network, the shopping cart order can be placed (manually or automatically) as soon as the mobile computing device re-establishes a connection with a data communication network.

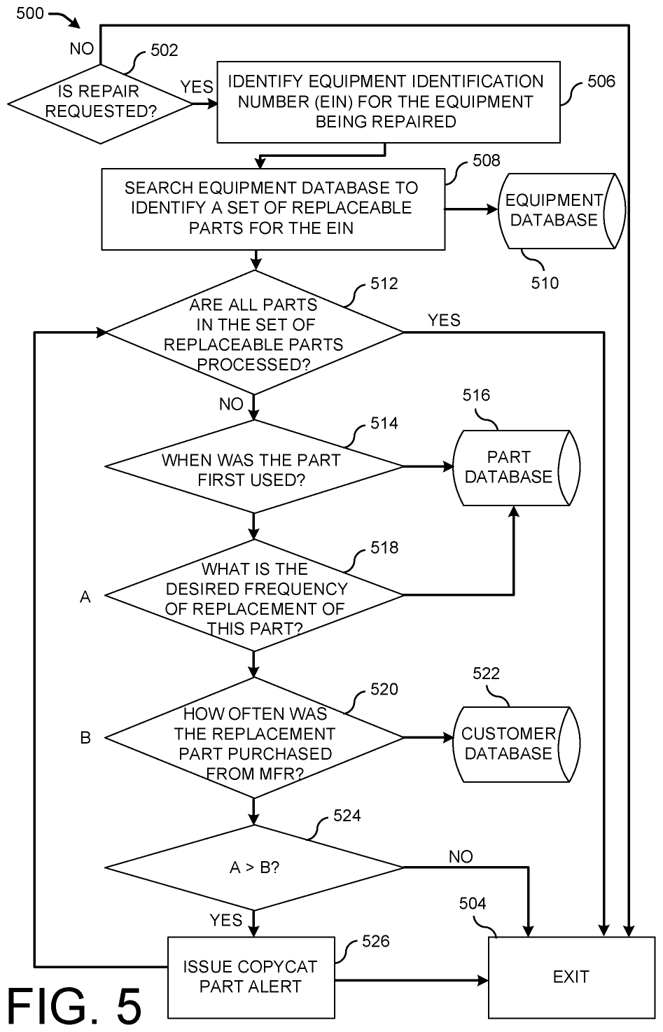

FIG. 5 is a flowchart showing a method 500 of determining whether a particular part is an authentic machine part, according to aspects of this disclosure. Initially, the method 500 determines 502 whether a repair of a machine or other system has been requested. If no repair was requested, the method 500 ends at 504.

If a repair was requested, the method 500 identifies 506 an equipment identification number (EIN) associated with the machine or equipment being repaired. The method 500 searches 508 an equipment database 510 to identify a set of replaceable parts for the EIN.

The method 500 continues by determining 512 whether all parts in the set of replaceable parts have been processed. If all parts have been processed, the method 500 ends at 504. If one or more parts remain to be processed, the method 500 continues to determine 514 when the part was first used based on information stored in a part database 516.

The method 500 then determines 518 the desired frequency of replacement of the part based on information stored in the part database 516. The method 500 also determines 520 how often the replacement part was purchased from the manufacturer (mfr) based on information stored in a customer database 522.

The method 500 compares 524 the desired frequency of replacement of the part with the information regarding how often the replacement part was purchased from the manufacturer. If the desired frequency of replacement is greater than the actual frequency of replacement, the method 500 determines 526 that the customer has used non-authentic (e.g., copycat) replacement parts. If the desired frequency of replacement is less than or equal to the actual frequency of replacement, the method 500 ends at 504.

FIG. 6 is a schematic illustration of a GUI 600 for selecting a machine, according to aspects of this disclosure. As shown in GUI 600, a user can select a particular type of machine by entering a prefix, serial number, or keywords associated with the machine. In some embodiments, the prefix identifies a particular type of machine or category of machine. In some examples, each machine has a unique serial number, which allows the user to select the specific machine. Additionally, the user can select one of the recently viewed machines shown with accompanying pictures of the machines.

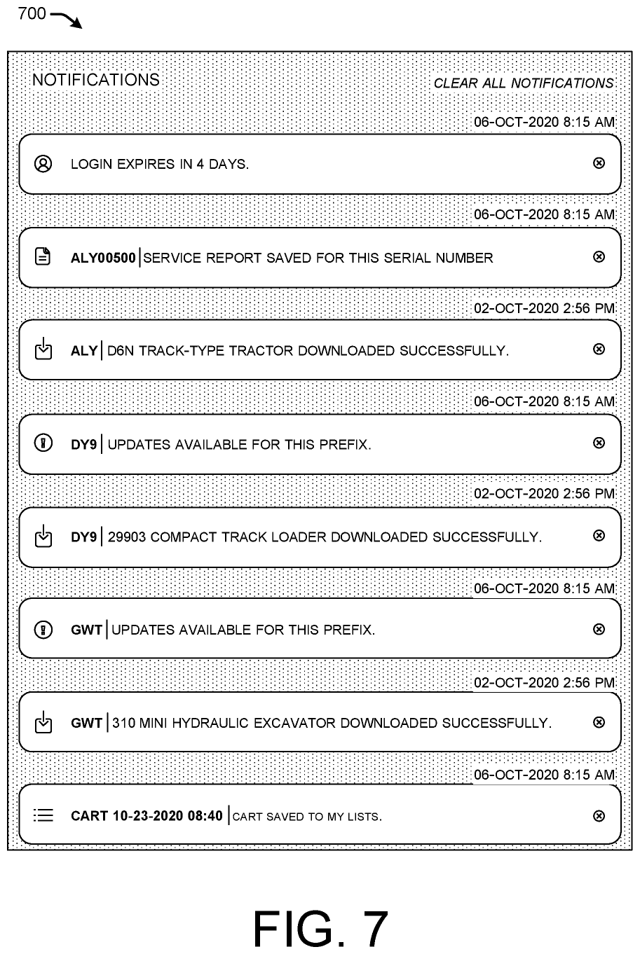

FIG. 7 is a schematic illustration of a GUI 700 displaying various notifications associated with a particular machine, according to aspects of this disclosure. The GUI 700 may include information regarding recent updates that are available, order status information, recent diagnostics or troubleshooting activities, and the like.

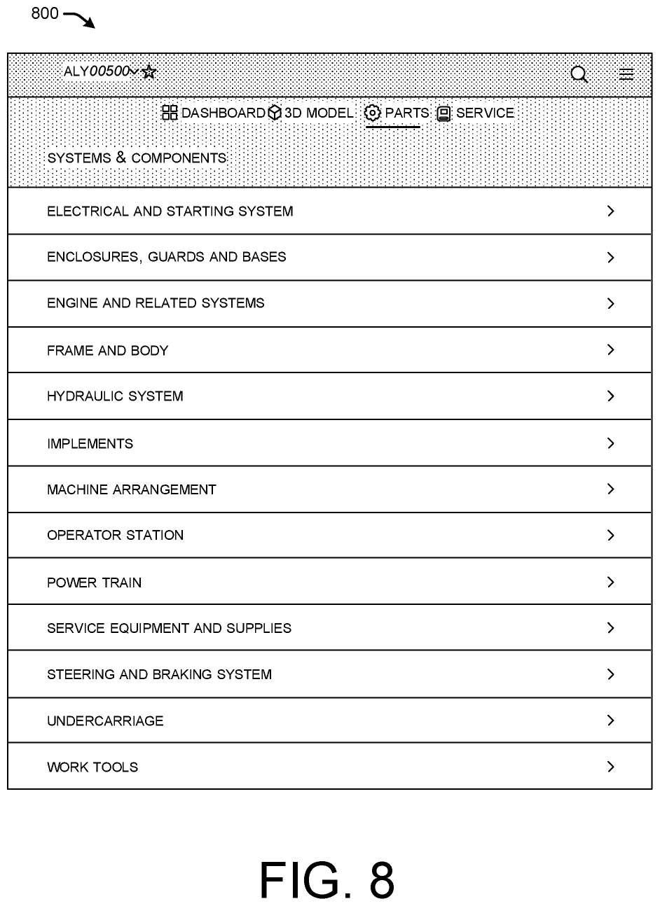

FIG. 8 is a schematic illustration of a GUI 800 displaying various systems and components associated with a particular machine, according to aspects of this disclosure. The GUI 800 may include information regarding various systems and components associated with a particular machine. These systems allow a user to focus their search for information on a specific part of the machine. For example, if the machine is having engine problems, the user may select the “Engine And Related Systems” for troubleshooting and diagnostic information for the steering problem.

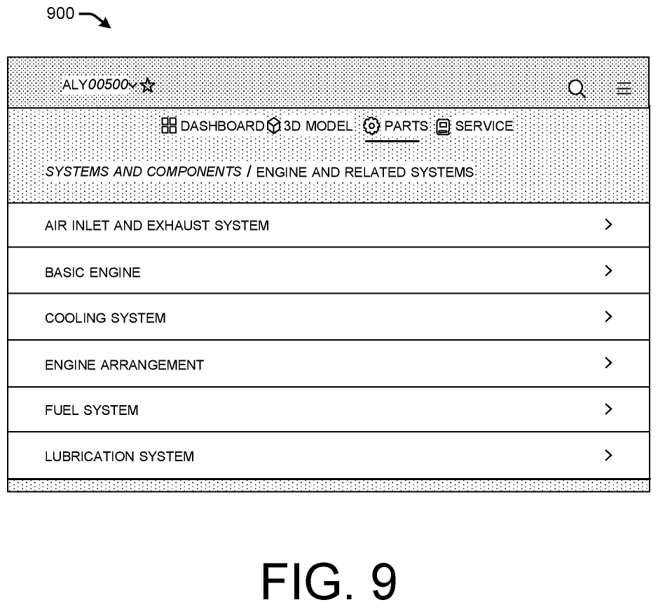

FIG. 9 is a schematic illustration of a GUI 900 displaying various systems and components associated with an engine and related systems, according to aspects of this disclosure. The GUI 900 may include information regarding sub-systems that are part of “Engine And Related Systems”, which allows the user to further focus their search.

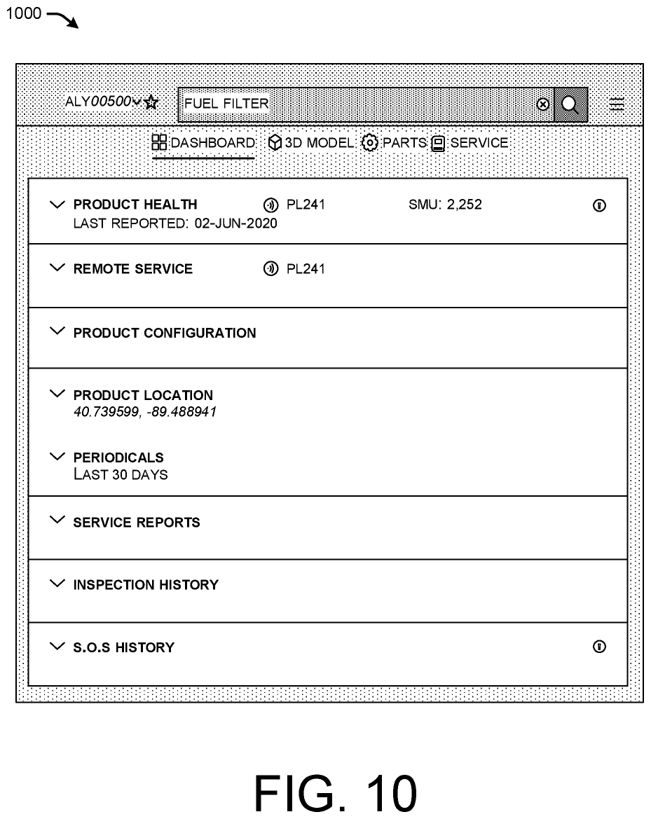

FIG. 10 is a schematic illustration of a GUI 1000 displaying various information available regarding a particular product, according to aspects of this disclosure. The GUI 1000 may include information regarding a particular part, such as a fuel filter. As shown in GUI 1000, various information is available to assist the user regarding fuel filters, such as product health, product configuration, product location, periodicals containing fuel filter information, and the like.

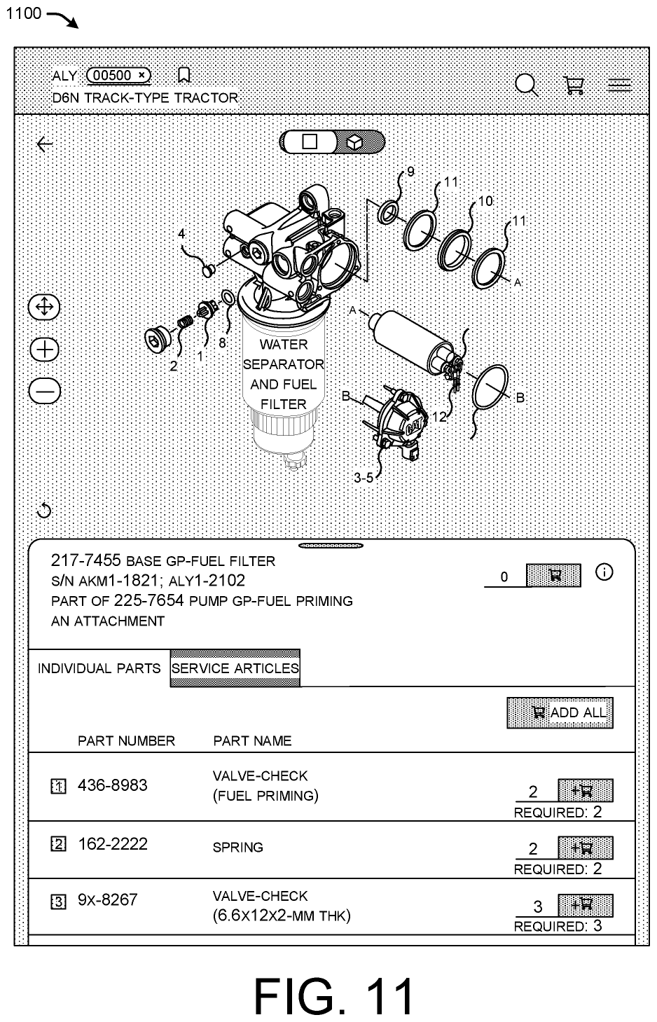

FIG. 11 is a schematic illustration of a GUI 1100 displaying example individual parts associated with a fuel filter, according to aspects of this disclosure. The GUI 1100 may include information regarding replacement parts available for the fuel filter, such as a check valve, a spring, and the like.

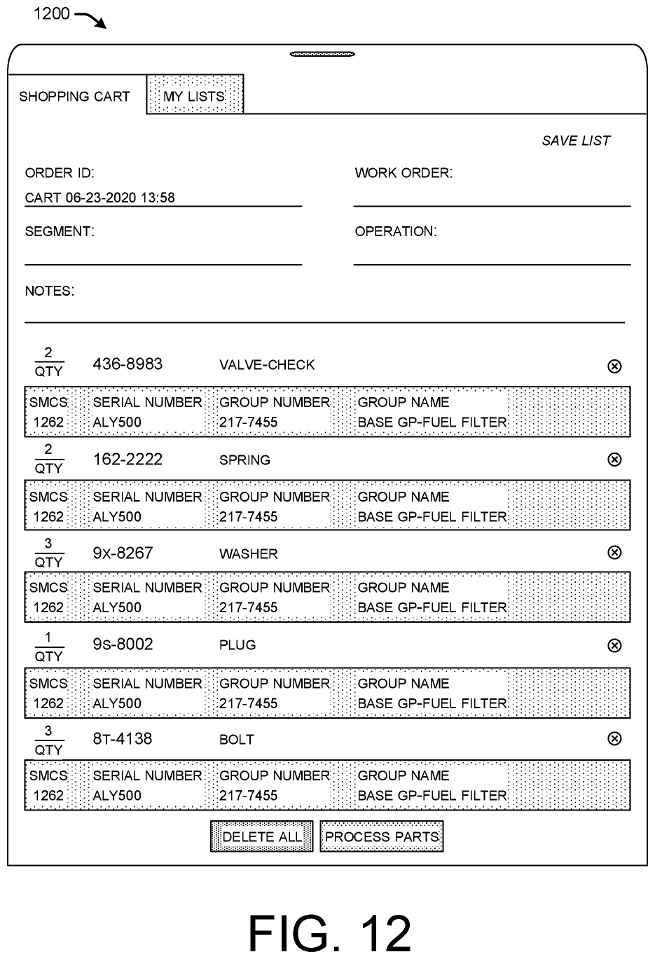

FIG. 12 is a schematic illustration of a GUI 1200 displaying an example shopping cart list of parts for a particular machine component, according to aspects of this disclosure. The GUI 1200 may include information regarding an order for one or more parts needed to repair a fuel filter or other part.

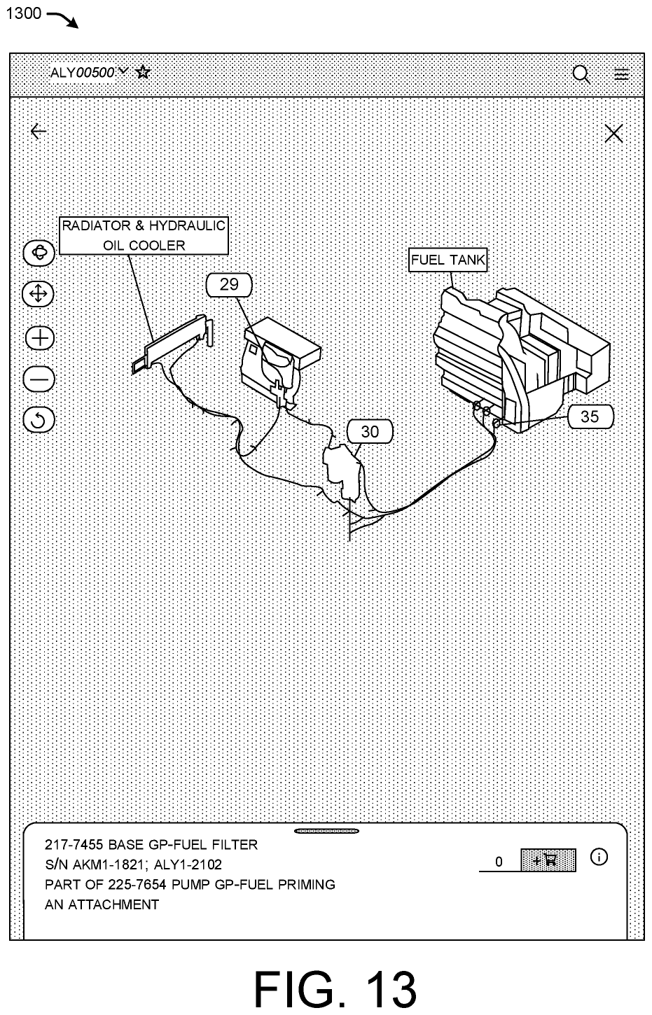

FIG. 13 is a schematic illustration of a GUI 1300 displaying an example fuel filter 3D parts image for a machine system, according to aspects of this disclosure. The GUI 1300 may include information illustrating the path for fuel flow or other system schematics. In other examples, a GUI may display an example wire tracing schematic or any other type of tracing schematic that shows the flow or routing of wires, tubes, conduits, hoses, or any other machine component(s).

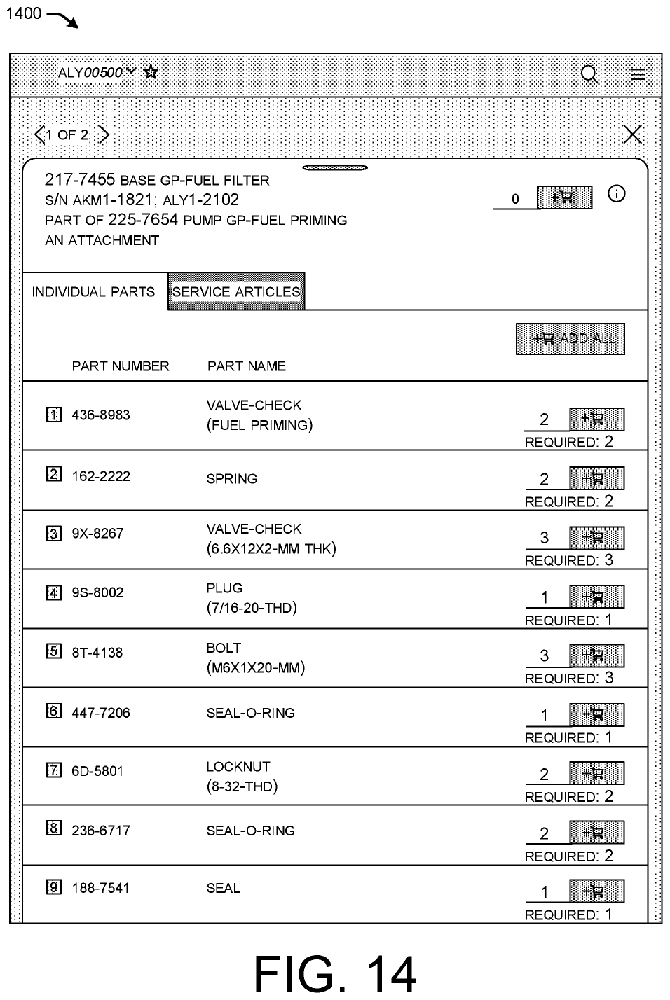

FIG. 14 is a schematic illustration of a GUI 1400 displaying example parts associated with a machine component and an option to add parts to a shopping cart, according to aspects of this disclosure. The GUI 1400 may include information regarding replacement parts available for a particular fuel filter.

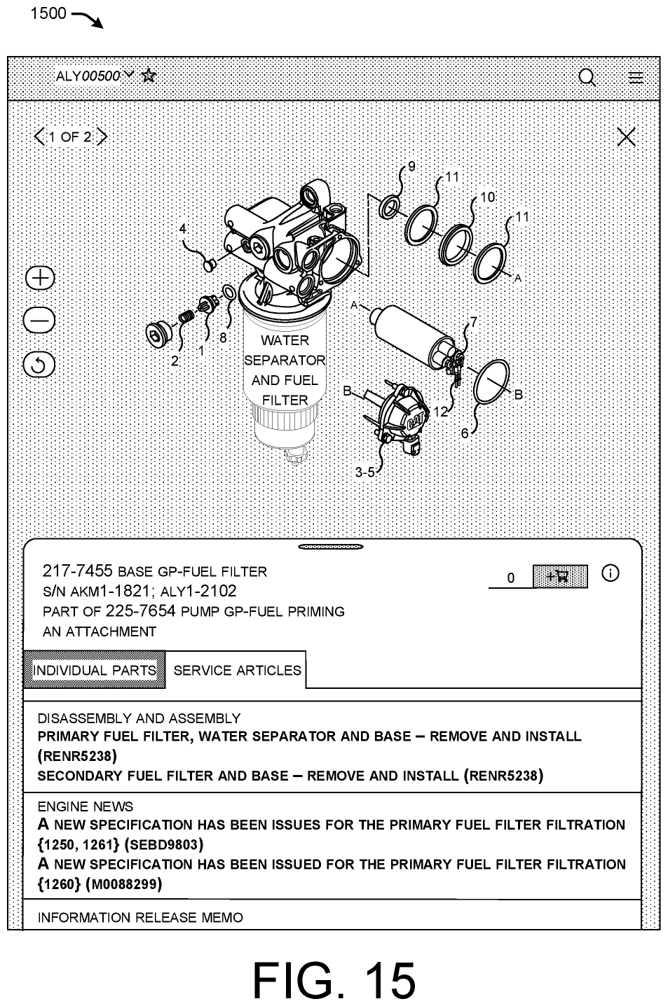

FIG. 15 is a schematic illustration of a GUI 1500 displaying available parts and service information related to a machine component, according to aspects of this disclosure. The GUI 1500 may include information regarding types of services available for a particular part, such as disassembly information, engine news, and the like.

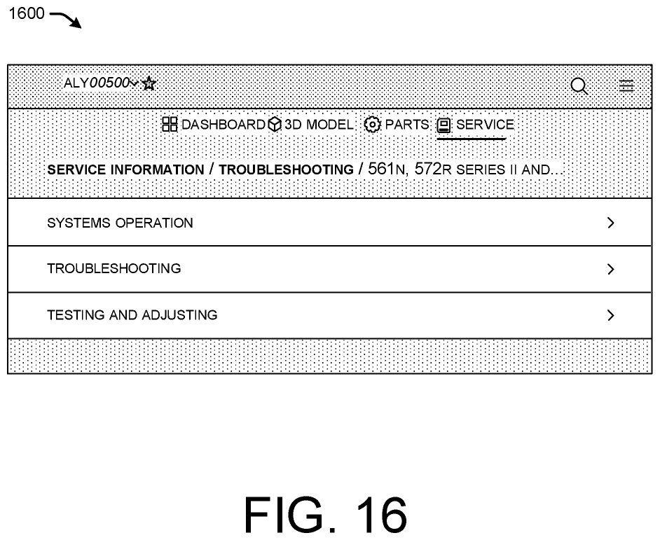

FIG. 16 is a schematic illustration of a GUI 1600 displaying available information related to systems operation, troubleshooting, and testing/adjusting, according to aspects of this disclosure. The GUI 1600 may include information regarding types of services available for a particular system or part, such as systems operation information, troubleshooting information, and testing and adjustment information.

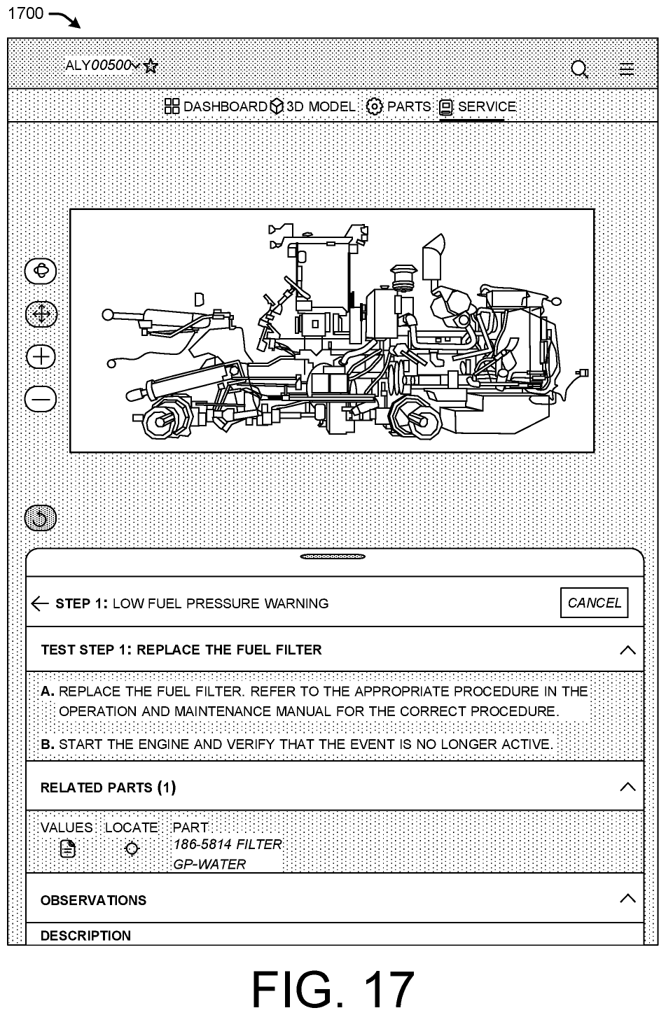

FIG. 17 is a schematic illustration of a GUI 1700 displaying a first step in troubleshooting an example low fuel pressure warning, according to aspects of this disclosure. The GUI 1700 may include information regarding actions for the user to take in a first troubleshooting step, such as replacing the fuel filter.

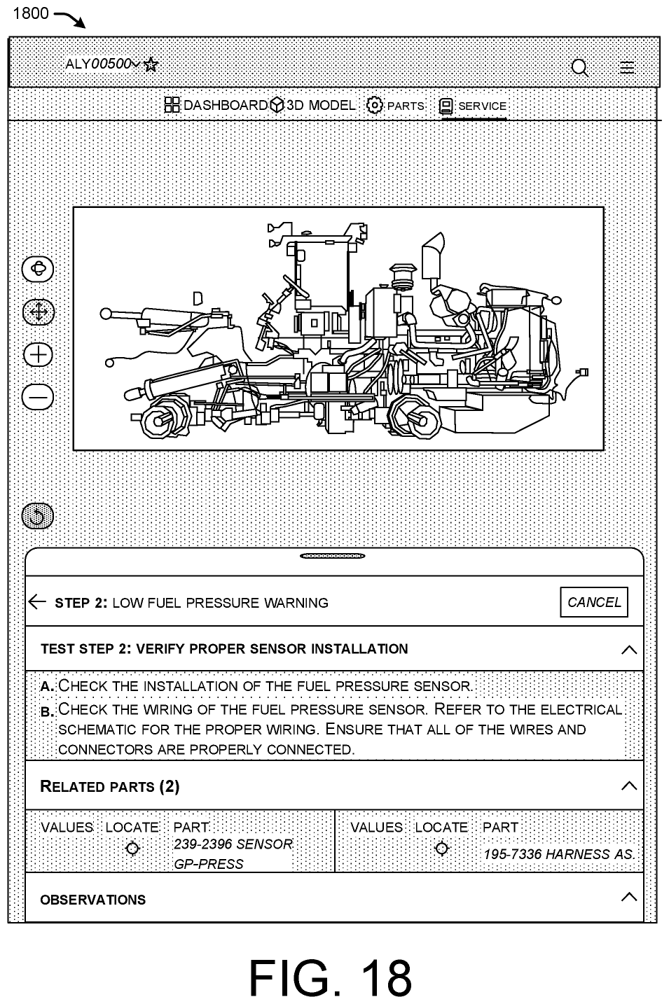

FIG. 18 is a schematic illustration of a GUI 1800 displaying a second step in troubleshooting an example low fuel pressure warning, according to aspects of this disclosure. The GUI 1800 may include information regarding actions for the user to take in a second troubleshooting step, such as verifying proper sensor installation.

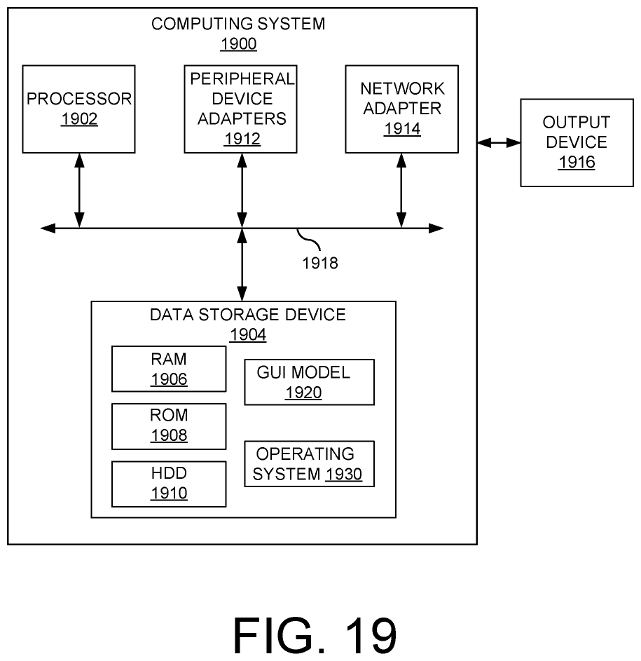

FIG. 19 is a block diagram of a computing system 1900 for execution of a method and GUIs, according to an example of the principles described herein. The computing system 1900 may be implemented in an electronic device. Examples of electronic devices include servers, desktop computers, laptop computers, personal digital assistants (PDAs), mobile devices, smartphones, gaming systems, and tablets, among other electronic devices. In some examples, at least a portion of the components shown in computing system 1900 may be included in computing device 102 and mobile computing device 108.

The computing system 1900 is utilized in any data processing scenario including, stand-alone hardware, mobile applications, through a computing network, or combinations thereof. Further, the computing system 1900 may be used in a computing network, a public cloud network, a private cloud network, a hybrid cloud network, other forms of networks, or combinations thereof. In one example, the methods provided by the computing system 1900 are provided as a service over a network by, for example, a third party. In this example, the service includes, for example, the following: a Software as a Service (SaaS) hosting a number of applications; a Platform as a Service (PaaS) hosting a computing platform including, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems are implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the computing system 1900 are executed by a local administrator.

To achieve its desired functionality, the computing system 1900 includes various hardware components. Among these hardware components include a processor 1902, a data storage device 1904, at least one peripheral device adapter 1912, and a network adapter 1914. These hardware components are interconnected through the use of a number of busses and/or network connections such as via a bus 1918.

The processor 1902 includes the hardware architecture to retrieve executable code from the data storage device 1904 and execute the executable code. The executable code, when executed by the processor 1902, causes the processor 1902 to implement at least the functionality according to the methods of the present specification described herein. In the course of executing code, the processor 1902 receives input from and provide output to a number of the remaining hardware units.

The data storage device 1904 stores data such as executable program code that is executed by the processor 1902 or other processing device. As described herein, the data storage device 1904 specifically stores computer code representing a number of applications that the processor 1902 executes to implement at least the functionality described herein.

The data storage device 1904 includes various types of memory modules, including volatile and nonvolatile memory. For example, the data storage device 1904 of the present example includes Random Access Memory (RAM) 1906, Read Only Memory (ROM) 1908, and Hard Disk Drive (HDD) memory 1910. Many other types of memory are also utilized, and the present specification contemplates the use of many varying type(s) of memory in the data storage device 1904 as may suit a particular application of the principles described herein. In certain examples, different types of memory in the data storage device 1904 are used for different data storage needs. For example, in certain examples the processor 1902 boots from ROM 1908, maintains nonvolatile storage in the HDD memory 1910, and executes program code stored in the RAM 1906.

The data storage device 1904 includes a computer readable medium, a computer readable storage medium, or a non-transitory computer readable medium, among others. For example, the data storage device 1904 is, but not limited to, an electronic, magnetic, optical, electromagnetic, infrared, or semiconductor system, apparatus, or device, or any suitable combination of the foregoing. More specific examples of the computer readable storage medium include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium is any tangible medium that can contain, or store computer usable program code for use by or in connection with an instruction execution system, apparatus, or device. In another example, a computer readable storage medium is any non-transitory medium that can contain or store a program for use by or in connection with an instruction execution system, apparatus, or device.

The peripheral device adapter 1912 and the network adapter 1914 act as hardware adapters in the computing system 1900 to enable the processor 1902 to interface with various other hardware elements, external and internal to the computing system 1900. For example, the peripheral device adapter 1912 provides an interface to input/output devices, such as, for example, an output device 1916, a mouse, and/or a keyboard. The peripheral device adapter 1912 also provides access to other external devices such as an external storage device, a number of network devices such as, for example, servers, switches, and routers, client devices, other types of computing devices, and combinations thereof.

The output device 1916 is provided to allow a user of the computing system 1900 to interact with and implement the functionality of the computing system 1900. The peripheral device adapter 1912 also creates an interface between the processor 1902 and the output device 1916, a printer, or other media output devices. The network adapter 1914 provides an interface to other computing devices within, for example, a network, thereby enabling the transmission of data between the computing system 1900 and other devices located within the network.

The computing system 1900, when executed by the processor 1902, displays any number of GUIs along with any associated elements on the output device 1916 (e.g., a display device) associated with the executable program code representing the number of applications stored on the data storage device 1904. The GUIs may include aspects of the executable code including those aspects described in the associated drawings. The GUIs may display, for example, any executable function described herein. Examples of output devices 1916 include a computer screen, a laptop screen, a mobile device screen, a personal digital assistant (PDA) screen, and a tablet screen, among other types of display devices.

The computing system 1900 further includes a number of modules used in the implementation of the functions of the GUIs described herein. The various modules within the computing system 1900 include executable program code that are executed separately. In this example, the various modules are stored as separate computer program products. In another example, the various modules within the computing system 1900 are combined within a number of computer program products; each computer program product including a number of the modules. For example, the computing system 1900 includes a GUI module 1920 to, when executed by the processor 1902, present the GUIs and receive a number of user inputs related to the plurality of selection interface elements as described herein.

The computing system 1900 is programmed with one or more operating systems (OS) 1930. The OS 1930 includes OS/2, Java Virtual Machine, Linux, SOLARIS, UNIX, HPUX, AIX, WINDOWS, WINDOWS95, WINDOWS98, WINDOWS NT, AND WINDOWS2000, WINDOWS ME, WINDOWS XP, WINDOWS SERVER, WINDOWS 8, Mac OS X, IOS, ANDROID among other platforms. At least a portion of the OS 1930 is disposed in the data storage device 1904.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that are stored in any type of computer-readable medium and are implemented in software and/or hardware. All of the methods and processes described above are embodied in, and fully automated via, software code components and/or computer-executable instructions executed by one or more computers or processors, hardware, or some combination thereof. Some or all of the methods are alternatively embodied in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions are deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

### INDUSTRIAL APPLICABILITY

The present disclosure describes systems and methods for managing data related to machine troubleshooting, machine servicing, machine maintenance, machine repairs, machine updates, and the like. Such systems and methods provide data update notifications so data stored on a mobile computing device is up-to-date when the mobile computing device is operated in, for example, a remote location without access to a data communication network. Further, the systems and methods limit the downloaded data to the mobile computing device to include data associated with the machine(s) that the user of the mobile computing device owns, rents, or is otherwise likely to service.

While aspects of the present disclosure have been particularly shown and described with reference to the examples above, it will be understood by those skilled in the art that various additional examples are contemplated by the modification of the disclosed machines, systems and methods without departing from the spirit and scope of what is disclosed. Such examples should be understood to fall within the scope of the present disclosure as determined based upon the claims and any equivalents thereof.

1. A method comprising, with a processor executing computer-readable instructions stored within a memory device:
displaying, on a display device and via at least one graphical user interface, a first interface element associated with a machine selection;
receiving, via the first interface element, a first input comprising an indication of a machine;
receiving, via the first interface element, a second input comprising an indication to download parts and service information associated with the machine;
initiating a download of the parts and service information associated with the machine from a computing device;
receiving the downloaded parts and service information associated with the machine;
storing the downloaded parts and service information associated with the machine in a mobile computing device associated with the processor; and
accessing the downloaded parts and service information associated with the machine using the mobile computing device when no data network connection is available.

2. The method of claim 1, further comprising:
receiving an indication that at least a portion of the downloaded parts and service information has been updated; and
displaying, via the mobile computing device, an indication that updated parts and service information has been updated.

3. The method of claim 2, further comprising:
receiving an input from a user of the mobile computing device to download the updated parts and service information;
initiating a download of the updated parts and service information associated with the machine from the computing device;
receiving the updated parts and service information associated with the machine; and
updating the parts and service information associated with the machine in the mobile computing device.

4. The method of claim 1, wherein the parts and service information associated with the machine includes at least one of text data, image data, audio data, video data, or step-by-step instructions.

5. The method of claim 1, further comprising:
determining at least one part required to fix a problem associated with the machine based on the parts and service information; and
generating an order for the at least one part required to fix the problem associated with the machine.

6. The method of claim 1, further comprising:
receiving input from a user attempting to fix a problem associated with the machine based on the parts and service information;
identifying a tool to use in fixing the problem associated with the machine based on the input from the user; and
displaying, on the mobile computing device, instructions for using the tool to the user attempting to fix the problem associated with the machine.

7. A method comprising, with a processor executing computer-readable instructions stored within a memory device:
identifying a machine being repaired;
identifying replaceable parts associated with the machine;
selecting a replaceable part to evaluate;
determining a desired frequency of replacement for the replaceable part;
determining an actual frequency that the replaceable part was purchased from a manufacturer; and
if the desired frequency of replacement for the replaceable part is greater than the actual frequency, classifying the replaceable part as a non-authentic replaceable part.

8. The method of claim 7, wherein identifying the replaceable parts associated with the machine includes accessing replaceable parts information from a parts database.

9. The method of claim 7, wherein determining the actual frequency that the replaceable part was purchased from the manufacturer includes accessing customer purchase information from a customer database.

10. The method of claim 7, wherein the non-authentic replaceable part is further classified as being manufactured by a third party.
